(19) United States
(12) Patent Application Publication
(10) Pub. No.: US 2010/0239718 A1
(43) Pub. Date: Sep. 23, 2010

(54) Use of polydimethylsiloxane and/or siloxane (silicone) derived chemical compounds in the suppression of mold and spoilage on harvested forages

(76) Inventor: Mark L. Folkman, Twin Falls, ID (US)

Correspondence Address: Mark L. Folkman, P.O. Box 5297, Twin Falls, ID, 83303, US

(21) Appl. No.: 12/383,076

(22) Filed: Mar. 19, 2009

(51) Int. Cl. A23K 1/00

(52) U.S. Cl. 426/89

(57) ABSTRACT

The invention outlines the use of polydimethylsiloxane (PDMS) copolymer and/or a siloxane derived chemical compounds in the suppression of mold, heating and spoilage in animal feedstuffs and forage products. The PDMS compound and derivatives thereof are also found to suppress the damage resulting from oxidation within the feedstuff mass. When applied, PDMS coats the feedstuff and is included in the moisture portion of the feed or forage mass. This helps preserve the feed quality and slows the damaging effects of spoilage organisms and oxidation.

### FIELD OF THE INVENTION

The present invention relates to the use of polydimethylsiloxane (PDMS) and siloxane (silicone) derived chemical compounds in the suppression of mold, heating and spoilage in feed and forage products normally used to feed animals preferably cattle.

### BACKGROUND OF THE INVENTION

Feedstuff commodity and forage products have been used for years as a food source for animals. Each product has been subject to spoilage through mold, heating and overall degradation. Several techniques and processes have been used in the past to slow or minimize the amount of loss typically found in forage and feedstuff products. Spoiled, heat damaged, or moldy feed can cause animals to become sick, lose weight, and/or drop in production in the case of commercial agricultural operations. Reducing spoilage improves animal health and economic return.

Large animal operations are one of the major uses of feedstuff and forage products. Typically these feeds are mixed with other ingredients to make a complete ration. Spoiled feed is particularly damaging to these large operations causing animals, typically cattle, to get sick. Spoilage is a major economic loss to large animal operations worldwide.

Another problem associated with spoilage in forage and feedstuff products are the hazards associated with damage to the feed product and facilities used to store these feed products. Oxidative heating in the feed or forage mass can cause self ignition resulting in severe damage to surrounding buildings and assets.

Care and protection of feedstuff and forage investments is a major subject of concern for many animal feed operations.

### SUMMARY OF THE INVENTION

Polydimethylsiloxane (PDMS) is derived from siloxane compound chemistry with a number of potential derivatives. When added to feedstuff and forage products, PDMS has been found to reduce heating, oxidation, mold growth, and spoilage. PDMS works by direct application to the feed product coating the surface of the feed mass to reduce spoilage and also through inclusion into the moisture portion of the feedstuff to do the same.

### DETAILED DESCRIPTION OF THE INVENTION

Polydimethylsiloxane (PDMS) is derived from siloxane compound chemistry with a number of potential derivatives. The formula for PDMS is as follows: R3-Si[Si(CH3)2O]nSi—R3 where R represents any organic or inorganic functional group typically (H3C)3Si[Si(CH3)2O]nSi(CH3)3 where n is the number of repeating monomer units making up the siloxane polymer molecule. Lower values of n will produce better effective results but benefit is also achieved using higher values of n as well. Because Polydimethylsiloxane (PDMS) is a polymer, a number of other chemical functional groups can be added as derivatives to the PDMS molecule but the key ingredient is the polydimethylsiloxane monomer.

Polydimethylsiloxane works by direct application to the feedstuff or forage product and allowing the silicone polymer compound to coat the surface of the product mass. The PDMS can be applied with water and/or a variety of carriers to assure optimum coverage.

Once applied to the feedstuff or forage mass, the PDMS compound reduces the effects of oxygen utilization at the surface of the feed product and in the moisture of the product mass.

One of the modes of action PDMS takes to suppress mold growth throughout the forage mass is by making it more difficult for mold to acquire nutrients and oxygen.

PDMS also suppresses heating in the forage mass by reducing the effect of available oxygen and hence the ability of the forage to oxidize during storage.

Silicone compounds including polydimethylsiloxane (PDMS) also have been found (though to a lesser degree) to reduce the surface tension in the forage commodity. Reducing the surface tension in given forages allows for available moisture to be more evenly distributed throughout the forage mass reducing high moisture “slugs” and allowing feed and forage products to be preserved tighter with less enclosed oxygen. PDMS can also be used to improve the harvestability of forage commodities in harvest equipment. The reduction of surface tension in the forage mass can also allow forage harvesting equipment to prepare a more consistent forage product.

What claimed is:

1. A composition for suppressing mold, heating, and spoilage in feed and forage products by coating these products with polydimethylsiloxane of the formula
R3-Si[Si(CH3)2O]nSi—R3 where R is any organic or inorganic functional group.

2. The composition of claim 1, where polydimethylsiloxane may contain any siloxane chemical derivative of the formula R3-Si[Si(CH3)2O]nSi—R3 where the value n is any number of repeating monomer units.

3. The composition of claim 1, where the siloxane molecule may contain other functional groups including a cyclic siloxane structure but where the functional molecule contains in whole or part the formula R3-Si[Si(CH3)2O]nSi—R3.

4. The composition of claim 1, where the feed commodity may include alfalfa hay.

5. The composition of claim 1, where the feed commodity may include alfalfa silage.

6. The composition of claim 1, where the feed commodity may include grass hay.

7. The composition of claim 1, where the feed commodity may include grass silage.

8. The composition of claim 1, where the feed commodity may include grain hay.

9. The composition of claim 1, where the feed commodity may include grain silage.

10. The composition of claim 8, where the grain hay may include barley, wheat, oats, rye, triticale, or other cereal grain.

11. The composition of claim 9, where the grain silage may include barley, wheat, oats, rye, triticale, or other cereal grain.

12. The composition of claim 1, where the feed commodity may include corn silage.

13. The composition of claim 1, where the feed commodity may include corn.

14. The composition of claim 1, where the feed commodity may include rolled, flaked, cracked, or processed corn.

15. The composition of claim 1, where the feed commodity may include any other harvested and/or stored forage commodity used as a food source in dairy, livestock or animal operations.

16. The composition of claim 2, where the amount of PDMS can range from 0.1 ppm to 40000 ppm of PDMS molecule in the feed mass on a dry matter basis.

17. The composition of claim 16, where PDMS can be mixed with live bacterial products to further enhance fermentation and/or preservation in the feed mass.

18. The composition of claim 16, where PDMS can be mixed with enzyme products to further enhance fermentation and/or preservation in the feed mass.

19. The composition of claim 16, where PDMS can be mixed with organic or mineral acid products to further enhance fermentation and/or preservation in the feed mass.
